(19) United States
(12) Patent Application Publication
(10) Pub. No.: US 2019/0111917 A1
(43) Pub. Date: Apr. 18, 2019

(54) AUTONOMOUS VEHICLE AND METHOD OF CONTROLLING THE SAME

(71) Applicant: LG Electronics Inc., Seoul (KR)

(72) Inventors: Cheolmun KIM, Seoul (KR); Sungpil YANG, Seoul (KR); Jinkyo LEE, Seoul (KR); Sukhwan CHO, Seoul (KR)

(21) Appl. No.: 16/121,987

(22) Filed: Sep. 5, 2018

(30) Foreign Application Priority Data
Oct. 12, 2017 (KR) 10-2017-0132313

(51) Int. Cl. B60W 30/06; G05D 1/00; G07C 5/00

(52) U.S. Cl. CPC B60W 30/06; G05D 1/0088; G05D 2201/0213; G07C 5/008; G05D 1/0011

(57) ABSTRACT

A method of monitoring parking of an autonomous vehicle, the method including: determining, based on at least one parameter, a monitoring mode for a parking operation of the autonomous vehicle; transmitting, according to the monitoring mode, driving information about the autonomous vehicle to at least one remote device; determining whether a command is received from the at least one remote device for controlling the parking operation of the autonomous vehicle; and controlling the parking operation of the autonomous vehicle based on the monitoring mode and based on a determination of whether a command is received from the at least one remote device for controlling the parking operation.

### CROSS-REFERENCE TO RELATED APPLICATIONS

This application claims the benefit of an earlier filing date and right of priority to Korean Patent Application No. 10-2017-0132313, filed on Oct. 12, 2017, which is hereby incorporated by reference as if fully set forth herein.

### TECHNICAL FIELD

The present disclosure relates to an autonomous vehicle and a method of controlling the same.

### BACKGROUND

A vehicle is an apparatus that is moved in a desired direction by a user riding therein. A typical example of the vehicle is an automobile.

Some vehicles are equipped with sensors and electronic devices to provide user convenience. For example, research has been actively conducted on an advanced driver assistance system (ADAS) to provide user convenience for various operations in driving. Further, autonomous vehicles are under active development.

### SUMMARY

Implementations are disclosed herein that enable an autonomous vehicle configured to allocate control of a parking operation of the vehicle in an adaptive manner.

In one aspect, a method of monitoring parking of an autonomous vehicle includes: determining, based on at least one parameter, a monitoring mode for a parking operation of the autonomous vehicle; transmitting, according to the monitoring mode, driving information about the autonomous vehicle to at least one remote device; determining whether a command is received from the at least one remote device for controlling the parking operation of the autonomous vehicle; and controlling the parking operation of the autonomous vehicle based on the monitoring mode and based on a determination of whether a command is received from the at least one remote device for controlling the parking operation.

In some implementations, the monitoring mode is one of a plurality of modes including an unforced monitoring mode and a forced monitoring mode.

In some implementations, the controlling of the parking operation of the autonomous vehicle based on the monitoring mode and based on the determination of whether a command is received from the at least one remote device further includes: based on a determination that the monitoring mode is the unforced monitoring mode, allocating control of the parking operation of the autonomous vehicle to the autonomous vehicle; and based on a determination that the monitoring mode is the forced monitoring mode, allocating the control of the parking operation of the autonomous vehicle to the at least one remote device.

In some implementations, the determination of a monitoring mode based on at least one parameter further includes: determining a distance between the at least one remote device and the autonomous vehicle; based on a determination that the distance satisfies at least one threshold criteria, determining that the monitoring mode is the unforced monitoring mode; and based on a determination that the distance does not satisfy the at least one threshold criteria, determining that the monitoring mode is the forced monitoring mode.

In some implementations, the determination of a monitoring mode based on at least one parameter further includes: determining whether a communication connection satisfying at least one connection criteria can be established between the at least one remote device and the autonomous vehicle; based on a determination that a communication connection satisfying the at least one connection criteria can be established, determining that the monitoring mode is the forced monitoring mode; and based on a determination that a communication connection satisfying the at least one connection criteria cannot be established, determining that the monitoring mode is the unforced monitoring mode.

In some implementations, the determination of a monitoring mode based on at least one parameter further includes: determining an expected time duration associated with the parking operation for the autonomous vehicle; based on a determination that the expected time duration is less than a threshold, determining that the monitoring mode is the forced monitoring mode; and based on a determination that the expected time duration is greater than or equal to the threshold, determining that the monitoring mode is the unforced monitoring mode.

In some implementations, the determination of a monitoring mode based on at least one parameter further includes: determining, based on at least one environmental condition of the autonomous vehicle, whether to implement a command that is received from the at least one remote device for controlling the parking operation of the autonomous vehicle; based on a determination to implement the command, determining that the monitoring mode is the forced monitoring mode; and based on a determination not to implement the command, determining that the monitoring mode is the unforced monitoring mode.

In some implementations, the at least one environmental condition includes one or more criteria to be satisfied in performing the parking operation, and the method further includes: determining to implement the command received from the at least one remote device in order to satisfy the one or more criteria for performing the parking operation.

In another aspect, an autonomous vehicle configured to monitor parking includes: a plurality of wheels; a power source configured to power a rotation of at least one of the plurality of wheels; and at least one processor. The at least one processor is configured to: determine, based on at least one parameter, a monitoring mode for a parking operation of the autonomous vehicle; transmit, according to the determined monitoring mode, driving information about the autonomous vehicle to at least one remote device; determine whether a command is received from the at least one remote device for controlling the parking operation of the autonomous vehicle; and control the parking operation of the autonomous vehicle based on the monitoring mode and based on a determination of whether a command is received from the at least one remote device for controlling the parking operation.

In some implementations, the monitoring mode is one of a plurality of modes including an unforced monitoring mode and a forced monitoring mode.

In some implementations, the at least one processor is configured to: allocate control of the parking operation of the autonomous vehicle to the autonomous vehicle based on a determination that the monitoring mode is the unforced monitoring mode; and allocate the control of the parking operation of the autonomous vehicle to the at least one remote device based on a determination that the monitoring mode is the forced monitoring mode.

In some implementations, the at least one processor is configured to: determine a distance between the at least one remote device and the autonomous vehicle; determine that the monitoring mode is the unforced monitoring mode based on a determination that the distance satisfies at least one threshold distance criteria; and determine that the monitoring mode is the forced monitoring mode based on a determination that the distance does not satisfy the at least one threshold distance criteria.

In some implementations, the at least one processor is configured to: determine whether a communication connection satisfying at least one connection criteria can be established between the at least one remote device and the autonomous vehicle; determine that the monitoring mode is the forced monitoring mode based on a determination that a communication connection satisfying the at least one connection criteria can be established; and determine that the monitoring mode is the unforced monitoring mode based on a determination that a communication connection satisfying the at least one connection criteria cannot be established.

In some implementations, the at least one processor is configured to: determine an expected time duration associated with the parking operation for the autonomous vehicle; determine that the monitoring mode is the forced monitoring mode based on a determination that the expected time duration is less than a threshold value; and determine that the monitoring mode is the unforced monitoring mode based on a determination that the expected time duration is greater than or equal to the threshold value.

In some implementations, the at least one processor is configured to: determine, based on at least one environmental condition of the autonomous vehicle, whether to implement a command that is received from the at least one remote device for controlling the parking operation of the autonomous vehicle; based on a determination to implement the command, determine that the monitoring mode is the forced monitoring mode; and based on a determination not to implement the command, determine that the monitoring mode is the unforced monitoring mode.

In some implementations, the at least one environmental condition includes one or more criteria to be satisfied in performing the parking operation, and the at least one processor is configured to: determine to implement the command received from the at least one remote device in order to satisfy the one or more criteria for performing the parking operation.

It is to be understood that both the foregoing general description and the following detailed description of the present disclosure are exemplary and explanatory and are intended to provide further explanation of the disclosure as claimed.

### BRIEF DESCRIPTION OF THE DRAWINGS

FIG. 1 is a diagram illustrating an example of the external appearance of a vehicle according to an implementation of the present disclosure;

FIG. 2 is a diagram illustrating examples of different angled views of the external appearance of a vehicle according to an implementation of the present disclosure;

FIGS. 3 and 4 are diagrams illustrating examples of the interior configuration of a vehicle according to an implementation of the present disclosure;

FIGS. 5 and 6 are diagrams illustrating various examples of object detection according to an implementation of the present disclosure;

FIG. 7 is a block diagram illustrating an example of a vehicle according to an implementation of the present disclosure;

FIG. 8 is a flowchart illustrating an example of monitoring a parking operation of an autonomous vehicle according to an implementation of the present disclosure;

FIG. 9 is a flowchart illustrating an example of determining a monitoring mode according to an implementation of the present disclosure;

FIG. 10 is a flowchart illustrating an example of determining a monitoring mode according to another implementation of the present disclosure;

FIG. 11 is a flowchart illustrating an example of determining a monitoring mode according to another implementation of the present disclosure;

FIG. 12 is a flowchart illustrating an example of determining a monitoring mode according to another implementation of the present disclosure; and

FIG. 13 is a flowchart illustrating an example of controlling a parking operation of an autonomous vehicle based on a command received from a remote device according to an implementation of the present disclosure.

### DETAILED DESCRIPTION

An autonomous vehicle may be configured to communicate with one or more remote devices for exchanging information regarding the vehicle, and also for enabling control of vehicle operations via the remote device(s). For example, an autonomous vehicle may implement various monitoring techniques for transmitting and receiving information with a remote device regarding a parking operation of the vehicle as well as commands for controlling the parking operation of the vehicle via the remote device.

In scenarios where a user monitors an autonomous vehicle during a parking operation, it may be desirable for the user to monitor the parking operation from a departure location to a destination location, to provide improved safety and control. However, a shortcoming with some monitoring techniques is that control of a parking process of an autonomous vehicle is not appropriately allocated between a remote device and the autonomous vehicle.

Implementations are disclosed herein that enable an autonomous vehicle that determines an appropriate monitoring mode for controlling a parking operation of the vehicle, and selectively allocates control of the parking operation either to the vehicle itself or to a remote device based on the monitoring mode. For example, if a first mode (an unforced monitoring mode) is determined, then the autonomous vehicle allocates control of parking of the vehicle to the vehicle itself, and if a second mode (a forced monitoring mode) is determined, then the autonomous vehicle allocates the control of parking of the vehicle to a remote device.

In some scenarios, the user may actively intervene in the parking operation of the autonomous vehicle, or may allow the autonomous vehicle to perform parking independently by allocating control of parking to the autonomous vehicle, according to the determined monitoring mode.

Therefore, the autonomous vehicle according to an implementation of the present disclosure achieves the technical effect that the control of parking of the autonomous vehicle may be adaptively and appropriately allocated either to the remote device or to at least one processor of the autonomous vehicle.

As will be apparent from the description given below, in some scenarios, the implementations of the present disclosure may have the following one or more effects.

First, the effect of distributing control of an autonomous vehicle is achieved by determining a particular mode of operating the vehicle (e.g., a forced monitoring mode or an unforced monitoring mode), based on the distance between a remote device and the autonomous vehicle.

Secondly, the effect of distributing control of an autonomous vehicle is achieved by determining a particular mode of operating the vehicle (e.g., a forced monitoring mode or an unforced monitoring mode), based on whether a suitable communication connection can be established between a remote device and the autonomous vehicle as a parameter.

Thirdly, the effect of distributing control of an autonomous vehicle is achieved by determining a mode of operating the vehicle (e.g., a forced monitoring mode or an unforced monitoring mode), based on a time expected to be taken for parking the autonomous vehicle as a parameter.

Fourthly, the effect of distributing control of an autonomous vehicle is achieved by determining a mode of operating the vehicle (e.g., a forced monitoring mode or an unforced monitoring mode), based on whether to implement a command received from a remote device for controlling parking of the autonomous vehicle (e.g., by determining whether the command is mandatory).

Additional advantages, effects, objects, and features of the disclosure will be set forth in part in the description which follows and in part will become apparent to those having ordinary skill in the art upon examination of the following or may be learned from practice of the disclosure. The objectives and other advantages of the disclosure may be realized and attained by the structure particularly pointed out in the written description and claims hereof as well as the appended drawings.

A vehicle as described in this specification may include any suitable motorized vehicle, such as an automobile and a motorcycle. Hereinafter, a description will be given based on an example of an automobile.

A vehicle as described in this specification may be powered by any suitable power source, and may include all of an internal combustion engine vehicle including an engine as a power source, a hybrid vehicle including both an engine and an electric motor as a power source, and an electric vehicle including an electric motor as a power source.

In the following description, “the left side of the vehicle” refers to the left side in the forward driving direction of the vehicle, and “the right side of the vehicle” refers to the right side in the forward driving direction of the vehicle.

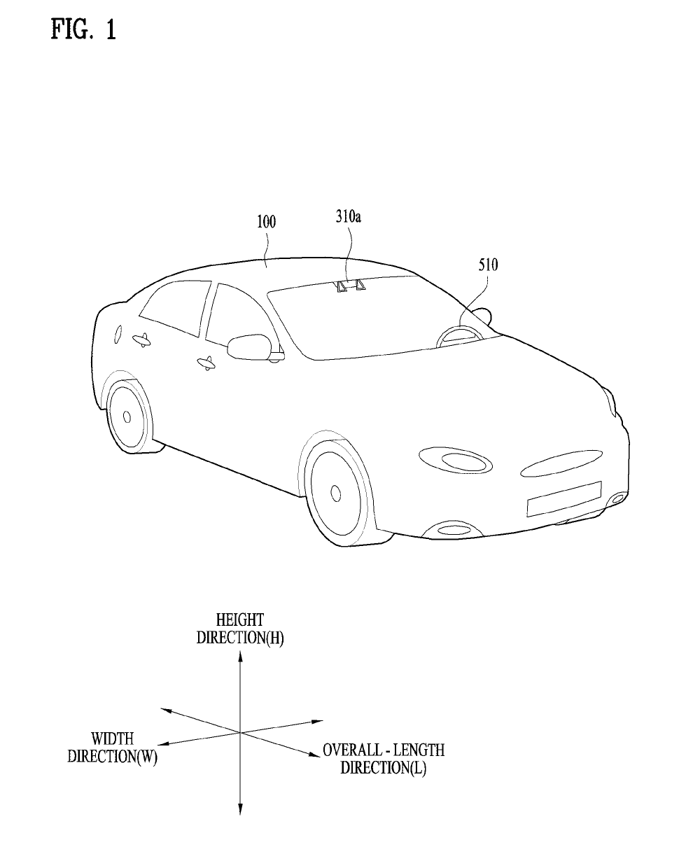

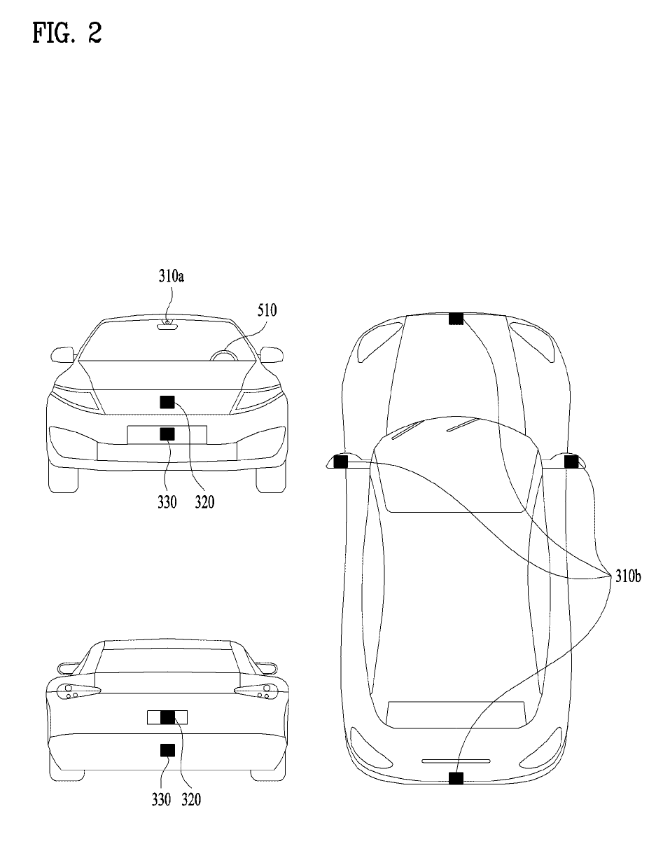

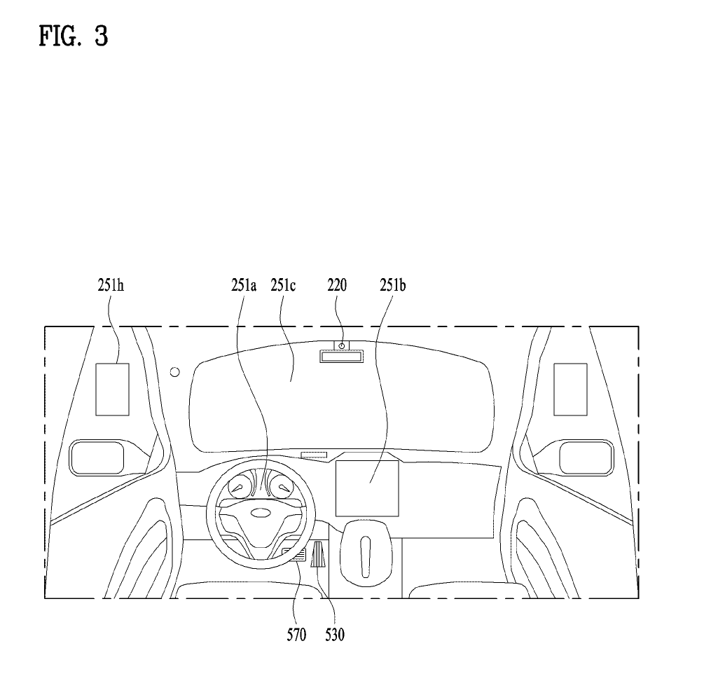

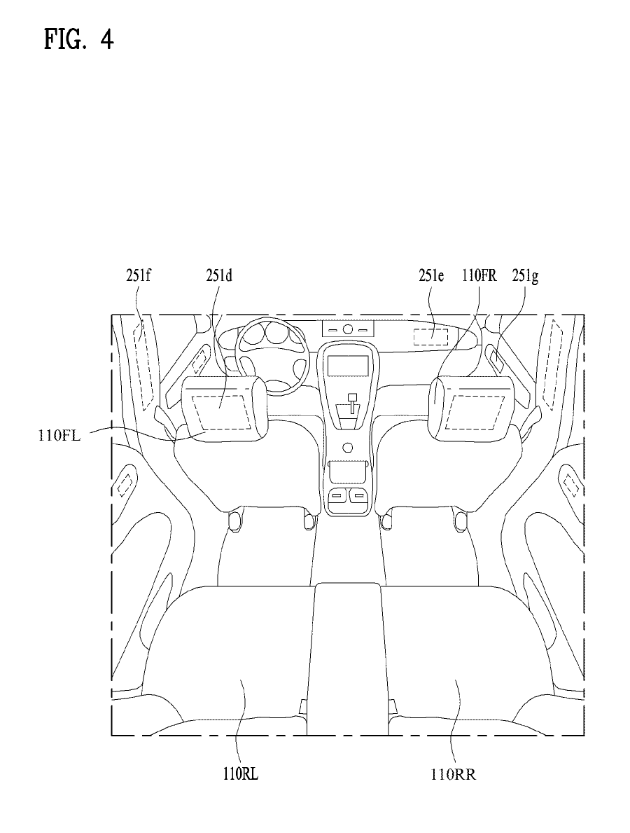

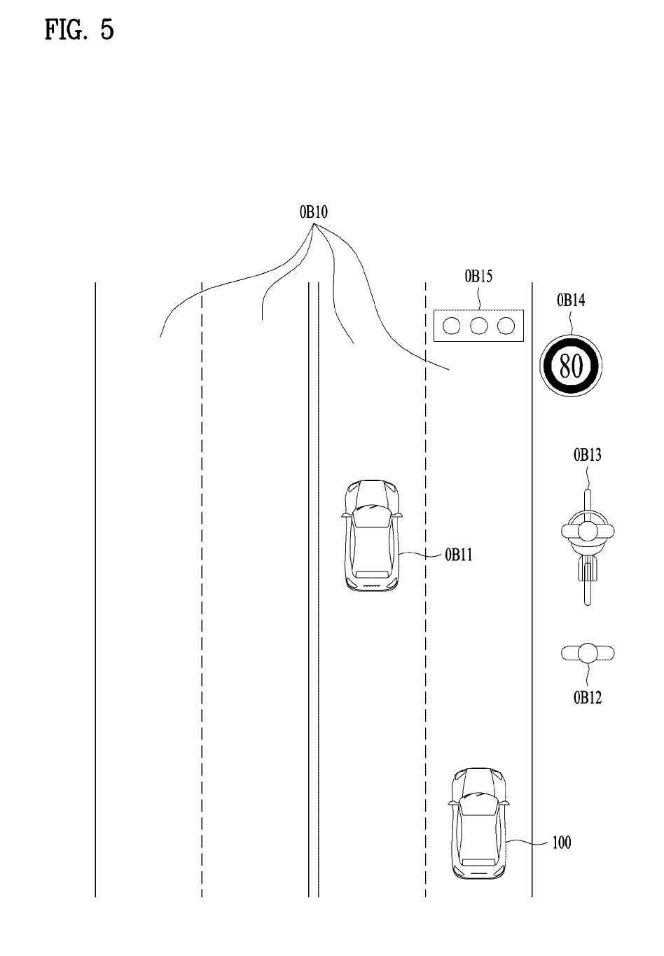

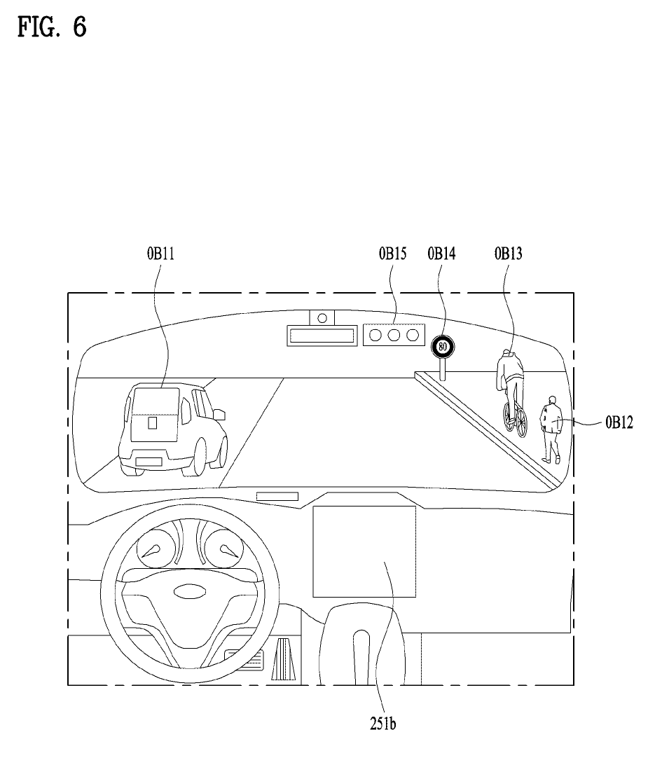

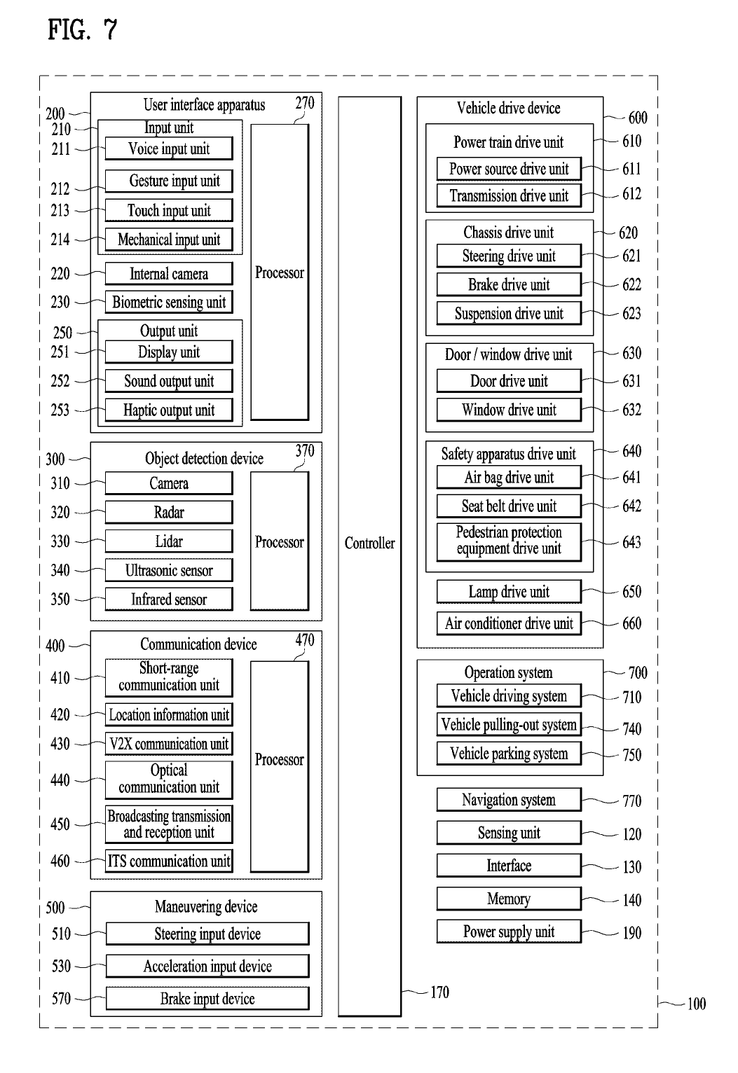

FIG. 1 is an example of the external appearance of a vehicle according to an implementation of the present disclosure, FIG. 2 is an example of different angled views of a vehicle according to an implementation of the present disclosure, FIGS. 3 and 4 are examples of the internal configuration of a vehicle according to an implementation of the present disclosure, FIGS. 5 and 6 are various example of object detection according to an implementation of the present disclosure, and FIG. 7 is a block diagram illustrating an example of a vehicle according to an implementation of the present disclosure.

Referring to FIGS. 1 to 7, a vehicle 100 may include a plurality of wheels, which are rotated by a power source, and a steering input device 510 for controlling a driving direction of the vehicle 100.

The vehicle 100 may be an autonomous vehicle.

In some implementations, the vehicle 100 may be switched to an autonomous mode or a manual mode.

As an example, in response to a user input received through a user interface device 200, the vehicle 100 may be switched from a manual mode to an autonomous mode, or vice versa.

As another example, the vehicle 100 may be switched to the autonomous mode or to the manual mode based on driving environment information.

The driving environment information may include at least one of the following:

information on an object outside a vehicle, navigation information, and vehicle state information.

For example, the vehicle 100 may be switched from the manual mode to the autonomous mode, or vice versa, based on driving environment information generated by the object detection device 300.

In another example, the vehicle 100 may be switched from the manual mode to the autonomous mode, or vice versa, based on driving environment information received through a communication device 400.

The vehicle 100 may be switched from the manual mode to the autonomous mode, or vice versa, based on information, data, and a signal provided from an external device.

When the vehicle 100 operates in the autonomous mode, the autonomous vehicle 100 may operate based on an operation system 700.

For example, the autonomous vehicle 100 may operate based on information, data, or signals generated by a driving system 710, a vehicle pulling-out system 740, and a vehicle parking system 750.

While operating in the manual mode, the autonomous vehicle 100 may receive a user input for driving of the vehicle 100 through a maneuvering device 500. In response to the user input received through the maneuvering device 500, the vehicle 100 may operate.

The term “overall length” refers to the length from the front end to the rear end of the vehicle 100, the term “overall width” refers to the width of the vehicle 100, and the term “overall height” refers to the height from the bottom of the wheel to the roof. In the following description, the term “overall length direction L” may mean the reference direction for the measurement of the overall length of the vehicle 100, the term “overall width direction W” may mean the reference direction for the measurement of the overall width of the vehicle 100, and the term “overall height direction H” may mean the reference direction for the measurement of the overall height of the vehicle 100.

As illustrated in FIG. 7, the vehicle 100 may include the user interface device 200, the object detection device 300, the communication device 400, the maneuvering device 500, a vehicle drive device 600, the operation system 700, a navigation system 770, a sensing unit 120, an interface 130, a memory 140, a controller 170, and a power supply unit 190.

In some implementations, the vehicle 100 may further include other components in addition to the aforementioned components, or may not include some of the aforementioned components.

The sensing unit 120 may sense the state of the vehicle. The sensing unit 120 may include an attitude sensor (for example, a yaw sensor, a roll sensor, or a pitch sensor), a collision sensor, a wheel sensor, a speed sensor, a gradient sensor, a weight sensor, a heading sensor, a gyro sensor, a position module, a vehicle forward/reverse movement sensor, a battery sensor, a fuel sensor, a tire sensor, a steering sensor based on the rotation of the steering wheel, an in-vehicle temperature sensor, an in-vehicle humidity sensor, an ultrasonic sensor, an illumination sensor, an accelerator pedal position sensor, and a brake pedal position sensor.

The sensing unit 120 may acquire sensing signals with regard to, for example, vehicle attitude information, vehicle collision information, vehicle driving direction information, vehicle location information (GPS information), vehicle angle information, vehicle speed information, vehicle acceleration information, vehicle tilt information, vehicle forward/reverse movement information, battery information, fuel information, tire information, vehicle lamp information, in-vehicle temperature information, in-vehicle humidity information, steering-wheel rotation angle information, outside illumination information, information about the pressure applied to an accelerator pedal, and information about the pressure applied to a brake pedal.

The sensing unit 120 may further include, for example, an accelerator pedal sensor, a pressure sensor, an engine speed sensor, an Air Flow-rate Sensor (AFS), an Air Temperature Sensor (ATS), a Water Temperature Sensor (WTS), a Throttle Position Sensor (TPS), a Top Dead Center (TDC) sensor, and a Crank Angle Sensor (CAS).

The sensing unit 120 may generate vehicle state information based on sensing data. The vehicle condition information may be information that is generated based on data sensed by a variety of sensors inside a vehicle.

For example, the vehicle state information may include vehicle position information, vehicle speed information, vehicle tilt information, vehicle weight information, vehicle direction information, vehicle battery information, vehicle fuel information, vehicle tire pressure information, vehicle steering information, in-vehicle temperature information, in-vehicle humidity information, pedal position information, vehicle engine temperature information, etc.

The interface 130 may serve as a passage for various kinds of external devices that are connected to the vehicle 100. For example, the interface 130 may have a port that is connectable to a mobile terminal and may be connected to the mobile terminal via the port. In this case, the interface 130 may exchange data with the mobile terminal.

In some implementations, the interface 130 may serve as a passage for the supply of electrical energy to a mobile terminal connected thereto. When the mobile terminal is electrically connected to the interface 130, the interface 130 may provide electrical energy, supplied from the power supply unit 190, to the mobile terminal under control of the controller 170.

The memory 140 is electrically connected to the controller 170. The memory 140 may store basic data for each unit, control data for the operational control of each unit, and input/output data. The memory 140 may be any of various hardware storage devices, such as a ROM, a RAM, an EPROM, a flash drive, and a hard drive. The memory 140 may store various data for the overall operation of the vehicle 100, such as programs for the processing or control of the controller 170.

In some implementations, the memory 140 may be integrally formed with the controller 170, or may be provided as an element of the controller 170.

The controller 170 may control the overall operation of each unit inside the vehicle 100. The controller 170 may be referred to as an Electronic Controller (ECU).

The power supply unit 190 may supply power required to operate each component under control of the controller 170. In particular, the power supply unit 190 may receive power from, for example, a battery inside the vehicle 100.

At least one processor and the controller 170 included in the vehicle 100 may be implemented using at least one selected from among Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, microprocessors, and electric units for the implementation of other functions.

Further, each of the sensing unit 120, the interface unit 130, the memory 140, the power supply unit 190, the user interface device 200, the object detection device 300, the communication device 400, the maneuvering device 500, the vehicle drive device 600, the operation system 700, and the navigation system 770 may have an individual processor or may be incorporated in the controller 170.

The user interface device 200 is provided to support communication between the vehicle 100 and a user. The user interface device 200 may receive a user input, and provide information generated in the vehicle 100 to the user. The vehicle 100 may enable User Interfaces (UI) or User Experience (UX) through the user interface device 200.

The user interface device 200 may include an input unit 210, an internal camera 220, a biometric sensing unit 230, an output unit 250, and at least one processor, such as processor 270. Each component of the user interface device 200 may be separated from or integrated with the afore-described interface 130, structurally or operatively.

In some implementations, the user interface device 200 may further include other components in addition to the aforementioned components, or may not include some of the aforementioned components.

The input unit 210 is configured to receive information from a user, and data collected in the input unit 210 may be analyzed by the processor 270 and then processed into a control command of the user.

The input unit 210 may be disposed inside the vehicle 100. For example, the input unit 210 may be disposed in a region of a steering wheel, a region of an instrument panel, a region of a seat, a region of each pillar, a region of a door, a region of a center console, a region of a head lining, a region of a sun visor, a region of a windshield, or a region of a window.

The input unit 210 may include a voice input unit 211, a gesture input unit 212, a touch input unit 213, and a mechanical input unit 214.

The voice input unit 211 may convert a voice input of a user into an electrical signal. The converted electrical signal may be provided to the processor 270 or the controller 170.

The voice input unit 211 may include one or more microphones.

The gesture input unit 212 may convert a gesture input of a user into an electrical signal. The converted electrical signal may be provided to the processor 270 or the controller 170.

The gesture input unit 212 may include at least one selected from among an infrared sensor and an image sensor for sensing a gesture input of a user.

In some implementations, the gesture input unit 212 may sense a three-dimensional (3D) gesture input of a user. To this end, the gesture input unit 212 may include a plurality of light emitting units for outputting infrared light, or a plurality of image sensors.

The gesture input unit 212 may sense the 3D gesture input by employing a time of flight (TOF) scheme, a structured light scheme, or a disparity scheme.

The touch input unit 213 may convert a user's touch input into an electrical signal. The converted electrical signal may be provided to the processor 270 or the controller 170.

The touch input unit 213 may include a touch sensor for sensing a touch input of a user.

In some implementations, the touch input unit 210 may be formed integral with a display unit 251 to implement a touch screen. The touch screen may provide an input interface and an output interface between the vehicle 100 and the user.

The mechanical input unit 214 may include at least one selected from among a button, a dome switch, a jog wheel, and a jog switch. An electrical signal generated by the mechanical input unit 214 may be provided to the processor 270 or the controller 170.

The mechanical input unit 214 may be located on a steering wheel, a center fascia, a center console, a cockpit module, a door, etc.

The processor 270 may start a learning mode of the vehicle 100 in response to a user input to at least one of the afore-described voice input unit 211, gesture input unit 212, touch input unit 213, or mechanical input unit 214. In the learning mode, the vehicle 100 may learn a driving route and ambient environment of the vehicle 100. The learning mode will be described later in detail in relation to the object detection device 300 and the operation system 700.

The internal camera 220 may acquire images of the inside of the vehicle 100. The processor 270 may sense a user's condition based on the images of the inside of the vehicle 100.

The processor 270 may acquire information on an eye gaze of the user. The processor 270 may sense a gesture of the user from the images of the inside of the vehicle 100.

The biometric sensing unit 230 may acquire biometric information of the user. The biometric sensing unit 230 may include a sensor for acquire biometric information of the user, and may utilize the sensor to acquire finger print information, heart rate information, etc. of the user. The biometric information may be used for user authentication.

The output unit 250 is configured to generate a visual, audio, or tactile output.

The output unit 250 may include at least one selected from among a display unit 251, a sound output unit 252, and a haptic output unit 253.

The display unit 251 may display graphic objects corresponding to various types of information.

The display unit 251 may include at least one selected from among a Liquid Crystal Display (LCD), a Thin Film Transistor-Liquid Crystal Display (TFT LCD), an Organic Light-Emitting Diode (OLED), a flexible display, a 3D display, and an e-ink display.

The display unit 251 may form an inter-layer structure together with the touch input unit 213, or may be integrally formed with the touch input unit 213 to implement a touch screen.

The display unit 251 may be implemented as a head up display (HUD). When implemented as a HUD, the display unit 251 may include a projector module in order to output information through an image projected on a windshield or a window.

The display unit 251 may include a transparent display. The transparent display may be attached on the windshield or the window.

The transparent display may display a predetermined screen with a predetermined transparency. In order to achieve the transparency, the transparent display may include at least one selected from among a transparent Thin Film Electroluminescent (TFEL) display, an Organic Light Emitting Diode (OLED) display, a transparent Liquid Crystal Display (LCD), a transmissive transparent display, and a transparent Light Emitting Diode (LED) display. The transparency of the transparent display may be adjustable.

In some implementations, the user interface device 200 may include a plurality of display units 251a to 251g.

As shown in the examples of FIGS. 3 and 4, the plurality of display units 251a to 251g may be disposed in a region of a steering wheel (251a), a region of an instrument panel (251a, 251b, or 251e), a region of a seat (251d), a region of each pillar (251f), a region of a door (251g), a region of a center console, a region of a head lining, a region of a sun visor, a region of a windshield (251c), or a region of a window (251h).

The sound output unit 252 converts an electrical signal from the processor 270 or the controller 170 into an audio signal, and outputs the audio signal. To this end, the sound output unit 252 may include one or more speakers.

The haptic output unit 253 generates a tactile output. For example, the haptic output unit 253 may operate to vibrate a steering wheel, a safety belt, and seats 110FL, 110FR, 110RL, and 110RR so as to allow a user to recognize the output.

The processor 270 may control the overall operation of each unit of the user interface device 200.

In some implementations, the user interface device 200 may include a plurality of processors 270 or may not include the processor 270.

In a case where the user interface device 200 does not include the processor 270, the user interface device 200 may operate under control of the controller 170 or a processor of a different device inside the vehicle 100.

In some implementations, the user interface device 200 may be referred to as a display device for a vehicle.

The user interface device 200 may operate under control of the controller 170.

The object detection device 300 is used to detect an object outside the vehicle 100. The object detection device 300 may generate object information based on sensing data.

The object information may include information about the presence of an object, location information of the object, information on distance between the vehicle and the object, and the speed of the object relative to the vehicle 100.

The object may include various objects related to travelling of the vehicle 100.

Referring to FIGS. 5 and 6, an object o may include a lane OB10, a nearby vehicle OB11, a pedestrian OB12, a two-wheeled vehicle OB13, a traffic signal OB14 and OB15, a light, a road, a structure, a bump, a geographical feature, an animal, etc.

The lane OB10 may be a lane in which the vehicle 100 is traveling (hereinafter, referred to as the current driving lane), a lane next to the current driving lane, and a lane in which a vehicle travelling in the opposite direction is travelling. The lane OB10 may include left and right lines that define the lane.

The nearby vehicle OB11 may be a vehicle that is travelling in the vicinity of the vehicle 100. The nearby vehicle OB11 may be a vehicle within a predetermined distance from the vehicle 100. For example, the nearby vehicle OB11 may be a vehicle that is preceding or following the vehicle 100.

The pedestrian OB12 may be a person in the vicinity of the vehicle 100. The pedestrian OB12 may be a person within a predetermined distance from the vehicle 100. For example, the pedestrian OB12 may be a person on a sidewalk or on the roadway.

The two-wheeled vehicle OB13 is a vehicle that is located in the vicinity of the vehicle 100 and moves with two wheels. The two-wheeled vehicle OB13 may be a vehicle that has two wheels within a predetermined distance from the vehicle 100. For example, the two-wheeled vehicle OB13 may be a motorcycle or a bike on a sidewalk or the roadway.

The traffic signal may include a traffic light OB15, a traffic sign plate OB14, and a pattern or text painted on a road surface.

The light may be light generated by a lamp provided in the nearby vehicle. The light may be light generated by a street light. The light may be solar light.

The road may include a road surface, a curve, and slopes, such as an upward slope and a downward slope.

The structure may be a body located around the road in the state of being fixed onto the ground. For example, the structure may include a streetlight, a roadside tree, a building, a traffic light, and a bridge.

The geographical feature may include a mountain and a hill.

In some implementations, the object may be classified as a movable object or a stationary object. For example, the movable object may include a nearby vehicle and a pedestrian. For example, the stationary object may include a traffic signal, a road, and a structure.

The object detection device 300 may include a camera 310, a radar 320, a lidar 330, an ultrasonic sensor 340, an infrared sensor 350, and at least one processor such as processor 370. Each component of the object detection device may be separated from or integrated with the sensing unit, structurally or operatively.

In some implementations, the object detection device 300 may further include other components in addition to the aforementioned components, or may not include some of the aforementioned components.

The camera 310 may be located at an appropriate position outside the vehicle 100 in order to acquire images of the outside of the vehicle 100. The camera 310 may be a mono camera, a stereo camera 310a, an around view monitoring (AVM) camera 310b, or a 360-degree camera.

Using various image processing algorithms, the camera 310 may acquire location information of an object, information on distance to the object, and information on speed relative to the object.

For example, based on change in size over time of an object in acquired images, the camera 310 may acquire information on distance to the object and information on speed relative to the object.

For example, the camera 310 may acquire the information on distance to the object and the information on speed relative to the object by utilizing a pin hole model or by profiling a road surface.

For example, the camera 310 may acquire the information on distance to the object and the information on the speed relative to the object, based on information on disparity of stereo images acquired by a stereo camera 310a.

For example, the camera 310 may be disposed near a front windshield in the vehicle 100 in order to acquire images of the front of the vehicle 100. Alternatively, the camera 310 may be disposed around a front bumper or a radiator grill.

In another example, the camera 310 may be disposed near a rear glass in the vehicle 100 in order to acquire images of the rear of the vehicle 100. Alternatively, the camera 310 may be disposed around a rear bumper, a trunk, or a tailgate.

In yet another example, the camera 310 may be disposed near at least one of the side windows in the vehicle 100 in order to acquire images of the side of the vehicle 100. Alternatively, the camera 310 may be disposed around a side mirror, a fender, or a door.

The camera 310 may provide an acquired image to the processor 370.

The radar 320 may include an electromagnetic wave transmission unit and an electromagnetic wave reception unit. The radar 320 may be realized as a pulse radar or a continuous wave radar depending on the principle of emission of an electronic wave. In addition, the radar 320 may be realized as a Frequency Modulated Continuous Wave (FMCW) type radar or a Frequency Shift Keying (FSK) type radar depending on the waveform of a signal.

The radar 320 may detect an object through the medium of an electromagnetic wave by employing a time of flight (TOF) scheme or a phase-shift scheme, and may detect a location of the detected object, the distance to the detected object, and the speed relative to the detected object.

The radar 320 may be located at an appropriate position outside the vehicle 100 in order to sense an object located in front of the vehicle 100, an object located to the rear of the vehicle 100, or an object located to the side of the vehicle 100.

The lidar 330 may include a laser transmission unit and a laser reception unit. The lidar 330 may be implemented by the TOF scheme or the phase-shift scheme.

The lidar 330 may be implemented as a drive type lidar or a non-drive type lidar.

When implemented as the drive type lidar, the lidar 330 may rotate by a motor and detect an object in the vicinity of the vehicle 100.

When implemented as the non-drive type lidar, the lidar 330 may utilize a light steering technique to detect an object located within a predetermined distance from the vehicle 100.

The lidar 330 may detect an object through the medium of laser light by employing the TOF scheme or the phase-shift scheme, and may detect a location of the detected object, the distance to the detected object, and the speed relative to the detected object.

The lidar 330 may be located at an appropriate position outside the vehicle 100 in order to sense an object located in front of the vehicle 100, an object located to the rear of the vehicle 100, or an object located to the side of the vehicle 100.

The ultrasonic sensor 340 may include an ultrasonic wave transmission unit and an ultrasonic wave reception unit. The ultrasonic sensor 340 may detect an object based on an ultrasonic wave, and may detect a location of the detected object, the distance to the detected object, and the speed relative to the detected object.

The ultrasonic sensor 340 may be located at an appropriate position outside the vehicle 100 in order to detect an object located in front of the vehicle 100, an object located to the rear of the vehicle 100, and an object located to the side of the vehicle 100.

The infrared sensor 350 may include an infrared light transmission unit and an infrared light reception unit. The infrared sensor 350 may detect an object based on infrared light, and may detect a location of the detected object, the distance to the detected object, and the speed relative to the detected object.

The infrared sensor 350 may be located at an appropriate position outside the vehicle 100 in order to sense an object located in front of the vehicle 100, an object located to the rear of the vehicle 100, or an object located to the side of the vehicle 100.

The processor 370 may control the overall operation of each unit of the object detection device 300.

The processor 370 may detect or classify an object by comparing data sensed by the camera 310, the radar 320, the lidar 330, the ultrasonic sensor 340, and the infrared sensor 350 with pre-stored data.

The processor 370 may detect and track an object based on acquired images. The processor 370 may, for example, calculate the distance to the object and the speed relative to the object.

For example, the processor 370 may acquire information on the distance to the object and information on the speed relative to the object based on a variation in size over time of the object in acquired images.

In another example, the processor 370 may acquire information on the distance to the object or information on the speed relative to the object by employing a pin hole model or by profiling a road surface.

In yet another example, the processor 370 may acquire information on the distance to the object and information on the speed relative to the object based on information on disparity of stereo images acquired from the stereo camera 310a.

The processor 370 may detect and track an object based on a reflection electromagnetic wave which is formed as a result of reflection a transmission electromagnetic wave by the object. Based on the electromagnetic wave, the processor 370 may, for example, calculate the distance to the object and the speed relative to the object.

The processor 370 may detect and track an object based on a reflection laser light which is formed as a result of reflection of transmission laser by the object. Based on the laser light, the processor 370 may, for example, calculate the distance to the object and the speed relative to the object.

The processor 370 may detect and track an object based on a reflection ultrasonic wave which is formed as a result of reflection of a transmission ultrasonic wave by the object. Based on the ultrasonic wave, the processor 370 may, for example, calculate the distance to the object and the speed relative to the object.

The processor 370 may detect and track an object based on reflection infrared light which is formed as a result of reflection of transmission infrared light by the object. Based on the infrared light, the processor 370 may, for example, calculate the distance to the object and the speed relative to the object.

As described before, once the vehicle 100 starts the learning mode in response to a user input to the input unit 210, the processor 370 may store data sensed by the camera 310, the radar 320, the lidar 330, the ultrasonic sensor 340, and the infrared sensor 350 in the memory 140.

Each step of the learning mode based on analysis of stored data, and an operating mode following the learning mode will be described later in detail in relation to the operation system 700. According to an implementation, the object detection device 300 may include a plurality of processors 370 or no processor 370. For example, the camera 310, the radar 320, the lidar 330, the ultrasonic sensor 340, and the infrared sensor 350 may include individual processors.

In a case where the object detection device 300 does not include the processor 370, the object detection device 300 may operate under control of the controller 170 or a processor inside the vehicle 100.

The object detection device 300 may operate under control of the controller 170.

The communication device 400 is configured to perform communication with an external device. Here, the external device may be a nearby vehicle, a mobile terminal, or a server.

To perform communication, the communication device 400 may include at least one selected from among a transmission antenna, a reception antenna, a Radio Frequency (RF) circuit capable of implementing various communication protocols, and an RF device.

The communication device 400 may include a short-range communication unit 410, a location information unit 420, a V2X communication unit 430, an optical communication unit 440, a broadcast transmission and reception unit 450, an Intelligent Transport Systems (ITS) communication unit 460, and at least one processor such as processor 470.

In some implementations, the communication device 400 may further include other components in addition to the aforementioned components, or may not include some of the aforementioned components.

The short-range communication unit 410 is configured to perform short-range communication. The short-range communication unit 410 may support short-range communication using at least one selected from among Bluetooth™, Radio Frequency IDdentification (RFID), Infrared Data Association (IrDA), Ultra-WideBand (UWB), ZigBee, Near Field Communication (NFC), Wireless-Fidelity (Wi-Fi), Wi-Fi Direct, and Wireless USB (Wireless Universal Serial Bus).

The short-range communication unit 410 may form wireless area networks to perform short-range communication between the vehicle 100 and at least one external device.

The location information unit 420 is configured to acquire location information of the vehicle 100. For example, the location information unit 420 may include a Global Positioning System (GPS) module or a Differential Global Positioning System (DGPS) module.

The V2X communication unit 430 is configured to perform wireless communication between a vehicle and a server (e.g., vehicle-to-infra (V2I) communication), wireless communication between a vehicle and a nearby vehicle (e.g., vehicle-to-vehicle (V2V) communication), or wireless communication between a vehicle and a pedestrian (e.g., vehicle-to-pedestrian (V2P) communication).

The optical communication unit 440 is configured to perform communication with an external device through the medium of light. The optical communication unit 440 may include a light emitting unit, which converts an electrical signal into an optical signal and transmits the optical signal to the outside, and a light receiving unit which converts a received optical signal into an electrical signal.

In some implementations, the light emitting unit may be integrally formed with a lamp provided included in the vehicle 100.

The broadcast transmission and reception unit 450 is configured to receive a broadcast signal from an external broadcasting management server or transmit a broadcast signal to the broadcasting management server through a broadcasting channel. The broadcasting channel may include a satellite channel, and a terrestrial channel. The broadcast signal may include a TV broadcast signal, a radio broadcast signal, and a data broadcast signal.

The ITS communication unit 460 may exchange information, data, or signals with a traffic system. The ITS communication unit 460 may provide acquired information or data to the traffic system. The ITS communication unit 460 may receive information, data, or signals from the traffic system. For example, the ITS communication unit 460 may receive traffic information from the traffic system and provide the traffic information to the controller 170. In another example, the ITS communication unit 460 may receive a control signal from the traffic system, and provide the control signal to the controller 170 or a processor provided in the vehicle 100.

The processor 470 may control the overall operation of each unit of the communication device 400.

In some implementations, the communication device 400 may include a plurality of processors 470, or may not include the processor 470.

In a case where the communication device 400 does not include the processor 470, the communication device 400 may operate under control of the controller 170 or a processor of a device inside of the vehicle 100.

In some implementations, the communication device 400 may implement a vehicle display device, together with the user interface device 200. In this case, the vehicle display device may be referred to as a telematics device or an audio video navigation (AVN) device.

The communication device 400 may operate under control of the controller 170.

The maneuvering device 500 is configured to receive a user input for driving the vehicle 100.

In the manual mode, the vehicle 100 may operate based on a signal provided by the maneuvering device 500.

The maneuvering device 500 may include a steering input device 510, an acceleration input device 530, and a brake input device 570.

The steering input device 510 may receive a user input with regard to the direction of travel of the vehicle 100. The steering input device 510 may take the form of a wheel to enable a steering input through the rotation thereof. In some implementations, the steering input device may be provided as a touchscreen, a touch pad, or a button.

The acceleration input device 530 may receive a user input for acceleration of the vehicle 100. The brake input device 570 may receive a user input for deceleration of the vehicle 100. Each of the acceleration input device 530 and the brake input device 570 may take the form of a pedal. In some implementations, the acceleration input device or the break input device may be configured as a touch screen, a touch pad, or a button.

The maneuvering device 500 may operate under control of the controller 170.

The vehicle drive device 600 is configured to electrically control the operation of various devices of the vehicle 100.

The vehicle drive device 600 may include a power train drive unit 610, a chassis drive unit 620, a door/window drive unit 630, a safety apparatus drive unit 640, a lamp drive unit 650, and an air conditioner drive unit 660.

In some implementations, the vehicle drive device 600 may further include other components in addition to the aforementioned components, or may not include some of the aforementioned components.

In some implementations, the vehicle drive device 600 may include a processor. Each unit of the vehicle drive device 600 may include its own processor.

The power train drive unit 610 may control the operation of a power train.

The power train drive unit 610 may include a power source drive unit 611 and a transmission drive unit 612.

The power source drive unit 611 may control a power source of the vehicle 100.

In the case in which a fossil fuel-based engine is the power source, the power source drive unit 611 may perform electronic control of the engine. As such the power source drive unit 611 may control, for example, the output torque of the engine. The power source drive unit 611 may adjust the output toque of the engine under control of the controller 170.

In a case where an electric motor is the power source, the power source drive unit 611 may control the motor. The power source drive unit 611 may control, for example, the RPM and toque of the motor under control of the controller 170.

The transmission drive unit 612 may control a transmission.

The transmission drive unit 612 may adjust the state of the transmission. The transmission drive unit 612 may adjust a state of the transmission to a drive (D), reverse (R), neutral (N), or park (P) state.

In some implementations, in a case where an engine is the power source, the transmission drive unit 612 may adjust a gear-engaged state to the drive position D.

The chassis drive unit 620 may control the operation of a chassis.

The chassis drive unit 620 may include a steering drive unit 621, a brake drive unit 622, and a suspension drive unit 623.

The steering drive unit 621 may perform electronic control of a steering apparatus provided inside the vehicle 100. The steering drive unit 621 may change the direction of travel of the vehicle 100.

The brake drive unit 622 may perform electronic control of a brake apparatus provided inside the vehicle 100. For example, the brake drive unit 622 may reduce the speed of the vehicle 100 by controlling the operation of a brake located at a wheel.

In some implementations, the brake drive unit 622 may control a plurality of brakes individually. The brake drive unit 622 may apply a different degree-braking force to each wheel.

The suspension drive unit 623 may perform electronic control of a suspension apparatus inside the vehicle 100. For example, when the road surface is uneven, the suspension drive unit 623 may control the suspension apparatus so as to reduce the vibration of the vehicle 100.

In some implementations, the suspension drive unit 623 may control a plurality of suspensions individually.

The door/window drive unit 630 may perform electronic control of a door apparatus or a window apparatus inside the vehicle 100.

The door/window drive unit 630 may include a door drive unit 631 and a window drive unit 632.

The door drive unit 631 may control the door apparatus. The door drive unit 631 may control opening or closing of a plurality of doors included in the vehicle 100. The door drive unit 631 may control opening or closing of a trunk or a tail gate. The door drive unit 631 may control opening or closing of a sunroof.

The window drive unit 632 may perform electronic control of the window apparatus. The window drive unit 632 may control opening or closing of a plurality of windows included in the vehicle 100.

The safety apparatus drive unit 640 may perform electronic control of various safety apparatuses provided inside the vehicle 100.

The safety apparatus drive unit 640 may include an airbag drive unit 641, a safety belt drive unit 642, and a pedestrian protection equipment drive unit 643.

The airbag drive unit 641 may perform electronic control of an airbag apparatus inside the vehicle 100. For example, upon detection of a dangerous situation, the airbag drive unit 641 may control an airbag to be deployed.

The safety belt drive unit 642 may perform electronic control of a seatbelt apparatus inside the vehicle 100. For example, upon detection of a dangerous situation, the safety belt drive unit 642 may control passengers to be fixed onto seats 110FL, 110FR, 110RL, and 110RR with safety belts.

The pedestrian protection equipment drive unit 643 may perform electronic control of a hood lift and a pedestrian airbag. For example, upon detection of a collision with a pedestrian, the pedestrian protection equipment drive unit 643 may control a hood lift and a pedestrian airbag to be deployed.

The lamp drive unit 650 may perform electronic control of various lamp apparatuses provided inside the vehicle 100.

The air conditioner drive unit 660 may perform electronic control of an air conditioner inside the vehicle 100. For example, when the inner temperature of the vehicle 100 is high, an air conditioner drive unit 660 may operate the air conditioner so as to supply cool air to the inside of the vehicle 100.

The vehicle drive device 600 may include a processor. Each unit of the vehicle drive device 600 may include its own processor.

The vehicle drive device 600 may operate under control of the controller 170.

The operation system 700 is a system for controlling the overall driving operation of the vehicle 100. The operation system 700 may operate in the autonomous driving mode.

The operation system 700 may include the driving system 710, the vehicle pulling-out system 740, and the vehicle parking system 750.

In some implementations, the operation system 700 may further include other components in addition to the aforementioned components, or may not include some of the aforementioned component.

In some implementations, the operation system 700 may include at least one processor. Each unit of the operation system 700 may include its own processor(s).

In some implementations, the operation system 700 may control driving in the autonomous mode based on learning. In this case, the learning mode and an operating mode based on the premise of completion of learning may be performed. A description will be given below of a method of executing the learning mode and the operating mode by the processor(s) of the operation system 700.

The learning mode may be performed in the afore-described manual mode. In the learning mode, the processor(s) of the operation system 700 may learn a driving route and ambient environment of the vehicle 100.

The learning of the driving route may include generating map data for a route in which the vehicle 100 drives. Particularly, the processor(s) of the operation system 700 may generate map data based on information detected through the object detection device 300 during driving from a departure to a destination.

The learning of the ambient environment may include storing and analyzing information about an ambient environment of the vehicle 100 during driving and parking. Particularly, the processor(s) of the operation system 700 may store and analyze the information about the ambient environment of the vehicle based on information detected through the object detection device 300 during parking of the vehicle 100, for example, information about a location, size, and a fixed (or mobile) obstacle of a parking space.

The operating mode may be performed in the afore-described autonomous mode. The operating mode will be described based on the premise that the driving route or the ambient environment has been learned in the learning mode.

The operating mode may be performed in response to a user input through the input unit 210, or when the vehicle 100 reaches the learned driving route and parking space, the operating mode may be performed automatically.

The operating mode may include a semi-autonomous operating mode requiring some user's manipulations of the maneuvering device 500, and a full autonomous operating mode requiring no user's manipulation of the maneuvering device 500.

According to an implementation, the processor(s) of the operation system 700 may drive the vehicle 100 along the learned driving route by controlling the operation system 700 in the operating mode.

According to an implementation, the processor(s) of the operation system 700 may pull out the vehicle 100 from the learned parking space by controlling the vehicle pulling-out system 740 in the operating mode.

According to an implementation, the processor(s) of the operation system 700 may park the vehicle 100 in the learned parking space by controlling the vehicle parking system 750 in the operating mode. In some implementations, in a case where the operation system 700 is implemented as software, the operation system 700 may be implemented by at least one processor, such as controller 170.

In some implementations, the operation system 700 may be implemented by at least one selected from among the user interface device 200, the object detection device 300, the communication device 400, the vehicle drive device 600, and the controller 170.

The driving system 710 may perform driving of the vehicle 100.

The driving system 710 may perform driving of the vehicle 100 by providing a control signal to the vehicle drive device 600 in response to reception of navigation information from the navigation system 770.

The driving system 710 may perform driving of the vehicle 100 by providing a control signal to the vehicle drive device 600 in response to reception of object information from the object detection device 300.

The driving system 710 may perform driving of the vehicle 100 by providing a control signal to the vehicle drive device 600 in response to reception of a signal from an external device via the communication device 400.

In some implementations, the driving system 710 may be a system that drives the vehicle 100, including at least one of the user interface device 200, the object detection device 300, the communication device 400, the maneuvering device 500, the vehicle drive device 600, the navigation system 770, the sensing unit 120, or the controller 170.

The driving system 710 may be referred to as a vehicle driving control device.

The vehicle pulling-out system 740 may perform an operation of pulling the vehicle 100 out of a parking space.

The vehicle pulling-out system 740 may perform an operation of pulling the vehicle 100 out of a parking space, by providing a control signal to the vehicle drive device 600 in response to reception of navigation information from the navigation system 770.

The vehicle pulling-out system 740 may perform an operation of pulling the vehicle 100 out of a parking space, by providing a control signal to the vehicle drive device 600 in response to reception of object information from the object detection device 300.

The vehicle pulling-out system 740 may perform an operation of pulling the vehicle 100 out of a parking space, by providing a control signal to the vehicle drive device 600 in response to reception of a signal from an external device.

In some implementations, the vehicle pulling-out system 740 may be a system that performs pulling-out of the vehicle 100, including at least one of the user interface device 200, the object detection device 300, the communication device 400, the maneuvering device 500, the vehicle drive device 600, the navigation system 770, the sensing unit 120, or the controller 170.

The vehicle pulling-out system 740 may be referred to as a vehicle pulling-out control device.

The vehicle parking system 750 may perform an operation of parking the vehicle 100 in a parking space.

The vehicle parking system 750 may perform an operation of parking the vehicle 100 in a parking space, by providing a control signal to the vehicle drive device 600 in response to reception of navigation information from the navigation system 770.

The vehicle parking system 750 may perform an operation of parking the vehicle 100 in a parking space, by providing a control signal to the vehicle drive device 600 in response to reception of object information from the object detection device 300.

The vehicle parking system 750 may perform an operation of parking the vehicle 100 in a parking space, by providing a control signal to the vehicle drive device 600 in response to reception of a signal from an external device.

In some implementations, the vehicle parking system 750 may be a system that performs parking of the vehicle 100, including at least one of the user interface device 200, the object detection device 300, the communication device 400, the maneuvering device 500, the vehicle drive device 600, the navigation system 770, the sensing unit 120, or the controller 170.

The vehicle parking system 750 may be referred to as a vehicle parking control device.

The navigation system 770 may provide navigation information. The navigation information may include at least one selected from among map information, information on a set destination, information on a route to the set destination, information on various objects along the route, lane information, and information on a current location of the vehicle.

The navigation system 770 may include a memory and at least one processor. The memory may store navigation information. The processor may control the operation of the navigation system 770.

In some implementations, the navigation system 770 may update pre-stored information by receiving information from an external device via the communication device 400.

In some implementations, the navigation system 770 may be classified as an element of the user interface device 200.

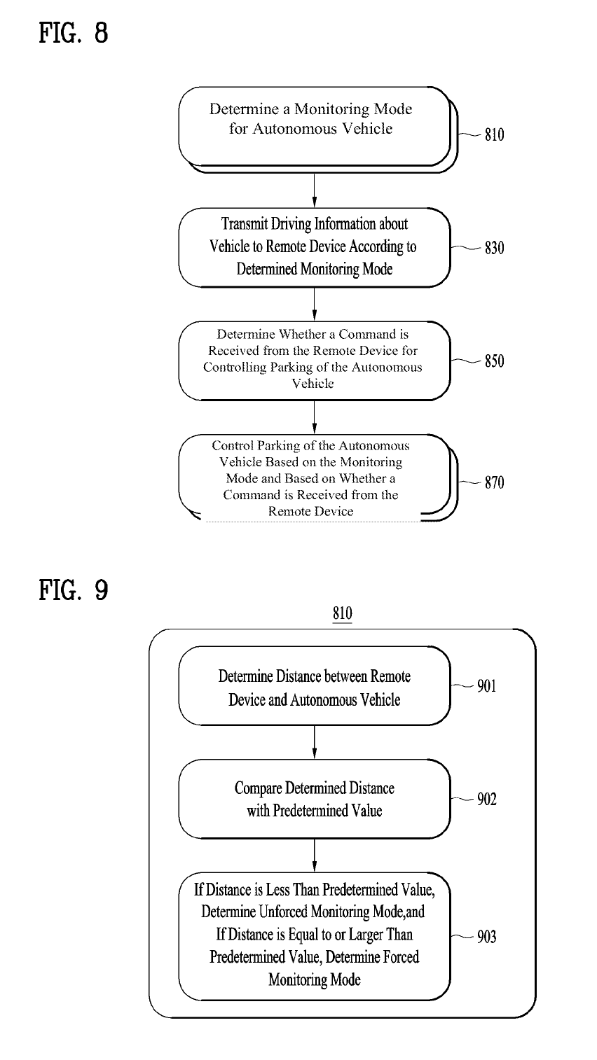

FIG. 8 is a flowchart illustrating an example of monitoring a parking operation of an autonomous vehicle according to an implementation of the present disclosure. In some implementations, the at least one processor of the vehicle 100, as described below, may correspond to the controller 170 illustrated in FIG. 7.

In step 810, the at least one processor of the autonomous vehicle 100 determines a monitoring mode for the vehicle 100 based on a plurality of parameters. Examples of the plurality of parameters are described below in detail with reference to FIGS. 9 to 12. In some implementations, the monitoring modes includes two modes. For example, in a first mode, which may be referred to as an unforced monitoring mode, the control of the parking operation of the vehicle 100 may be allocated to the vehicle 100 itself. In a second mode, which may be referred to as a forced monitoring mode, the control of the parking operation of the vehicle 100 may be allocated to the remote device.

In step 830, the processor of the autonomous vehicle 100 transmits driving information about the autonomous vehicle 100 to at least one remote device, according to the determined monitoring mode. The driving information may include any suitable information related to driving of the vehicle, including information about the vehicle itself or environmental conditions outside the vehicle. The at least one remote device, in some implementations, may be an external device apart from the autonomous vehicle 100, and may include another vehicle, a mobile terminal, or a server. The processor of the autonomous vehicle 100 is configured to communicate with the remote device, for example via the communication device 400 in FIG. 7.

In some scenarios, according to the monitoring mode, driving information may not be transmitted to the remote device. For example, if a suitable communication connection cannot be established between the vehicle 100 and the remote device, then the first mode (the unforced monitoring mode) may be determined, in which case driving information may not be transmitted to the remote device.

In step 850 of FIG. 8, the processor of the autonomous vehicle 100 determines whether a command is received from the remote device for controlling a parking operation of the autonomous vehicle 100. In some scenarios, depending on the monitoring mode, a command may not be received from the remote device. For example, if a suitable communication connection cannot be established between the vehicle 100 and the remote device, then the first mode (the unforced mode) may be determined, in which case a command may not be received from the remote device for controlling the parking operation.

In step 870, the processor of the autonomous vehicle 100 controls the parking operation of the autonomous vehicle 100 based on the monitoring mode and based on whether a command is received from the remote device. For example, according to an implementation of the present disclosure, the processor of the autonomous vehicle 100 distributes control of the parking operation for the autonomous vehicle 100 differently based on whether the first mode (the unforced monitoring mode) is determined or the second mode (the forced monitoring mode) is determined. In this regard, further description is given below with reference to FIG. 13.

FIG. 9 is a flowchart illustrating an example of determining a monitoring mode according to an implementation of the present disclosure. The operation illustrated in FIG. 9 may be understood as included in step 810 illustrated in FIG. 8.

In this example, in step 901, the at least one processor (e.g., controller 170) of the autonomous vehicle 100 determines a distance between a remote device of a user and the autonomous vehicle 100.

The distance between the remote device and the autonomous vehicle 100 may be determined by any suitable distance-measurement technique. For example, distance may be determined by radio frequency (RF) or low frequency (LF) communication. As other examples, the processor of the autonomous vehicle 100 may calculate the distance between the remote device and the autonomous vehicle 100 by using location information about the autonomous vehicle 100, determined through a global positioning system (GPS) module or differential global positioning system (DGPS) module included in the location information unit 420, and location information about the remote device, received via the communication device 400.

The processor then determines whether the distance between the remote device and the autonomous vehicle 100 satisfies at least one criterion and, based on that determination, operates the vehicle in one of two modes that distributes control of a parking operation of the vehicle 100.

For example, in step 902, the distance between the remote device and the autonomous vehicle 100 is compared with a threshold, which may be a predetermined value. The threshold may be set by a user input or may be automatically determined by the at least one processor.

Then, in step 903, if the distance between the remote device and the autonomous vehicle 100 is less than the predetermined value, then the processor of the autonomous vehicle 100 determines the first mode (the unforced monitoring mode).

In this scenario, if the first mode (the unforced monitoring mode) is determined, then control of parking of the autonomous vehicle 100 is allocated to the autonomous vehicle 100. In this case, even if the autonomous vehicle 100 does not receive a control signal via the remote device (e.g., step 850 of FIG. 8), the autonomous vehicle 100 may nonetheless autonomously perform the parking operation in the first mode (the unforced mode).

By contrast, if the distance between the remote device and the autonomous vehicle 100 is equal to or larger than the predetermined value, then the processor of the autonomous vehicle 100 determines the second mode (the forced monitoring mode).

In this scenario, if the second mode (the forced monitoring mode) is determined, then the control of parking of the autonomous vehicle 100 is allocated to the remote device. In this case, according to some implementations, only when the user transmits (e.g., continuously transmits) a control signal to the autonomous vehicle 100 via the remote device (e.g., step 850 of FIG. 8) does the autonomous vehicle 100 perform the parking operation (e.g., step 870 of FIG. 8).

However, the determination of the first mode or the second mode based on the distance between the remote device and the vehicle 100 is not limited to the foregoing description.

For example, a description is given below of a method of determining a monitoring mode according to another implementation of the present disclosure.

In some implementations, if the distance between the remote device of the user and the autonomous vehicle 100 is less than a threshold, such as a predetermined value, then this may correspond to the autonomous vehicle 100 being located within a range visible to the naked eye. In this case, according to some implementations, only when the user transmits (e.g., continuously transmits) a control signal to the autonomous vehicle 100 via the remote device (e.g., step 850 of FIG. 8) does the autonomous vehicle 100 perform the parking operation (e.g., step 870 of FIG. 8). This is an example of the control of parking of the autonomous vehicle 100 being allocated to the remote device according to the second mode (the forced monitoring mode).

The control signal may include a stop signal that stops the parking operation. For example, the stop signal may be generated due to entry of an obstacle such as another vehicle or a pedestrian into a driving route of the autonomous vehicle 100. As another example, the control signal may include a signal instructing continuation of the parking operation.

On the contrary, according to this alternative implementation, if the distance between the remote device of the user and the autonomous vehicle 100 is equal to or larger than the predetermined value, then this may correspond to the autonomous vehicle 100 being located outside the range visible to the naked eye. In this case, the autonomous vehicle 100 may autonomously perform parking even though the autonomous vehicle 100 does not receive a control signal via the remote device (e.g., step 850 of FIG. 8). This is an example of the control of parking of the autonomous vehicle 100 being allocated to the autonomous vehicle 100 according to the first mode (the unforced monitoring mode).

In this first mode (the unforced monitoring mode), the autonomous vehicle 100 may autonomously perform parking along a driving route using one or more sensors and/or communication devices, such as the object detection device, the communication device 400, and so on.

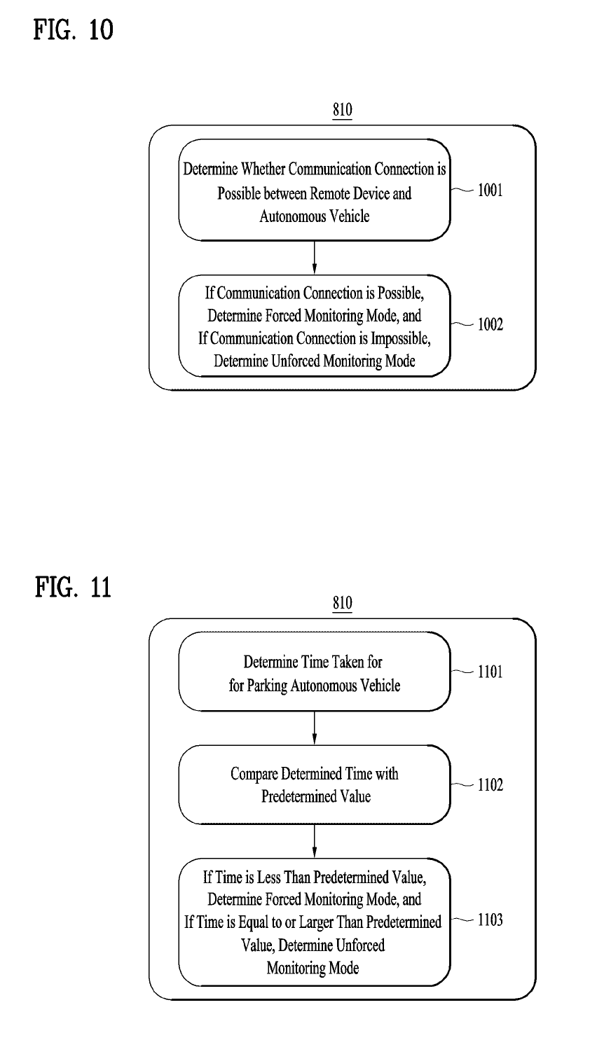

FIG. 10 is a flowchart illustrating an example of determining a monitoring mode according to another implementation of the present disclosure. The operation illustrated in FIG. 10 may be understood as included in step 810 illustrated in FIG. 8.

First, in step 1001, the at least one processor (e.g., controller 170) of the autonomous vehicle 100 determines whether the autonomous vehicle 100 can establish a suitable communication connection with the remote device. This determination of whether the autonomous vehicle 100 can establish a suitable communication connection with the remote device may be made in a variety of ways.

As examples, this determination may be made based on strength or quality of communication signals, responsiveness of the remote device, or other suitable criteria indicating connectivity between the vehicle 100 and the remote device. For example, the processor of the autonomous vehicle 100 may determine whether a communication connection may be established with the remote device by using the communication device 400 including the short-range communication unit 410, the location information unit 420, the V2X communication unit 430, the optical communication unit 440, the broadcast transmission and reception unit 450, and the ITS communication unit 460.

Then, in step 1002, if a suitable communication connection can be established between the remote device and the autonomous vehicle 100, then the processor of the autonomous vehicle 100 determines the second mode (the forced monitoring mode). If the second mode (the forced monitoring mode) is determined, then the control of parking of the autonomous vehicle 100 is allocated to the remote device. In this case, according to some implementations, only when the user transmits (e.g., continuously transmits) a control signal to the autonomous vehicle 100 via the remote device (e.g., step 850 of FIG. 8) does the autonomous vehicle 100 perform parking as in step 870 of FIG. 8.

As examples, the user may transmit a control signal instructing slow driving, entry with obstacle avoidance, stop, bypass path generation, or the like to the autonomous vehicle 100 via the remote device.

By contrast, if a suitable communication connection cannot be established between the remote device and the autonomous vehicle 100, then the processor of the autonomous vehicle 100 determines the first mode (the unforced monitoring mode). If the first mode (the unforced monitoring mode) is determined, then the control of parking of the autonomous vehicle 100 is allocated to the autonomous vehicle 100. In this case, the autonomous vehicle 100 may autonomously perform parking even though the autonomous vehicle 100 does not receive a control signal from the remote device (e.g., in step 850 of FIG. 8).

FIG. 11 is a flowchart illustrating an example of determining a monitoring mode according to another implementation of the present disclosure. The operation illustrated in FIG. 11 may be understood as included in step 810 illustrated in FIG. 8.

In step 1101, the at least one processor (e.g., controller 170) of the autonomous vehicle 100 determines a time expected to be taken to park the autonomous vehicle 100. The determination of the time taken to park the vehicle 100 may be made according to various criteria. For example, the expected time taken for parking may be made based on: (i) the physical distance between the autonomous vehicle 100 and a parking space, (ii) the presence of objects, such as a fixed obstacle or wall, along a path to the parking space and a corresponding time to move to the parking space due to the fixed obstacle or a wall, or (iii) the presence of other vehicles, for example other vehicles waiting to park, and the corresponding time to move to the parking space due to the other vehicles waiting to be parked. In general, the time taken for parking the vehicle 100 may be made according to various criteria based on the physical location of the vehicle 100 relative to the parking space.

In step 1102, the processor of the autonomous vehicle 100 determines whether the expected time taken for parking satisfies at least one criteria. For example, the processor may compare the determined time taken for parking with a predetermined value. The value may be preset via the user interface device 200 by the user or may be automatically determined by the at least one processor.

Based on a determination of whether the expected time taken for parking satisfies the at least one criteria, the processor determines one of two modes for controlling parking of the vehicle 100.

For example, in step 1103, if the expected time taken for parking is equal to or larger than the predetermined value, then the processor of the autonomous vehicle 100 determines the first mode (the unforced monitoring mode). If the first mode (the unforced monitoring mode) is determined, then the control of parking of the autonomous vehicle 100 is allocated to the autonomous vehicle 100. In this case, the autonomous vehicle 100 may autonomously perform parking even though the autonomous vehicle 100 does not receive a control signal via the remote device in step 850 of FIG. 8.

By contrast, if the expected time taken for parking is less than the predetermined value, then the processor of the autonomous vehicle 100 determines the second mode (the forced monitoring mode). If the second mode (the forced monitoring mode) is determined, then the control of parking of the autonomous vehicle 100 is allocated to the remote device. In this case, according to some implementations, only when the user transmits (e.g., continuously transmits) a control signal to the autonomous vehicle 100 via the remote device (e.g., step 850 of FIG. 8) does the autonomous vehicle 100 perform parking as in step 870 of FIG. 8.

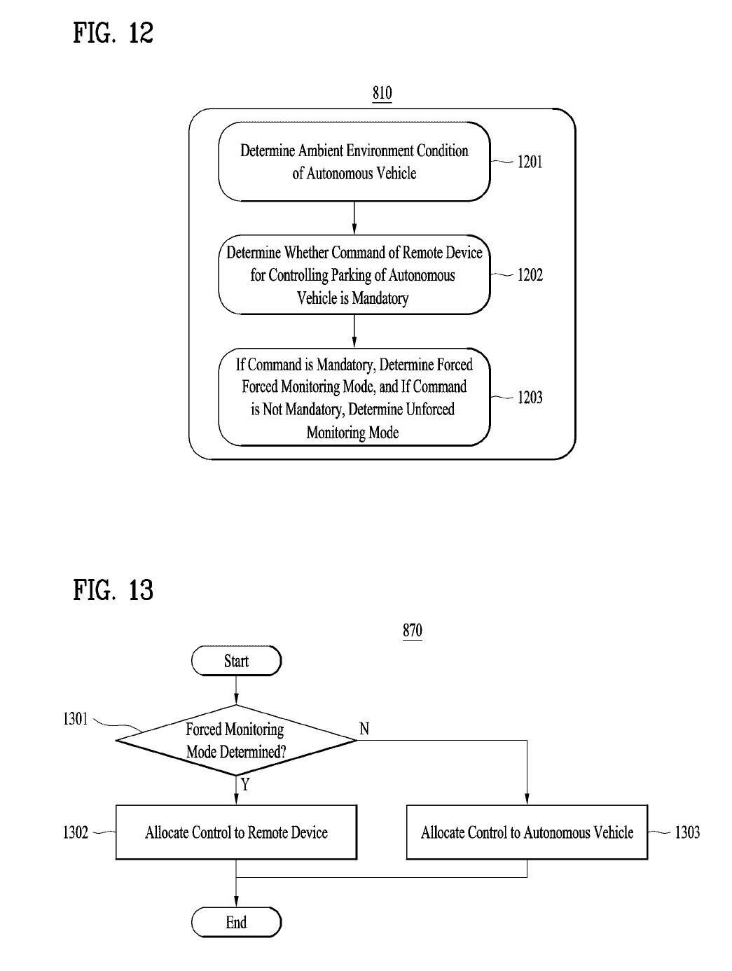

FIG. 12 is a flowchart illustrating an example of determining a monitoring method according to another implementation of the present disclosure. The operation illustrated in FIG. 12 may be understood as included in step 810 illustrated in FIG. 8.

In step 1201, the at least one processor (e.g., controller 170) of the autonomous vehicle 100 determines an ambient environmental condition of the autonomous vehicle 100. The ambient environmental condition of the autonomous vehicle 100 may relate to various types of factors outside the vehicle 100, some examples of which are given further below.

In step 1202, based on the ambient environment conditions, the processor of the autonomous vehicle 100 determines whether to implement a command that is received from the remote device for controlling parking of the autonomous vehicle 100. For example, in some implementations, the processor may determine whether the command received from the remote device is mandatory such that it must be implemented.

In step 1203, if the processor determines to implement the command received from the remote device (e.g., determines that the command is mandatory), then the processor may determine the second mode (the forced monitoring mode). Otherwise, if the processor determines not to implement the command received from the remote device (e.g., determines that the command is not mandatory), then the processor may determine the first mode (the unforced monitoring mode).

Further description will be given below of various examples of environmental conditions of the autonomous vehicle 100 and subsequently determining whether to implement a command received from the remote device (e.g., determining whether the command is mandatory).

As an example, the environmental condition may relate to a level of congestion outside the vehicle 100. The level of congestion may indicate, for example, a number of moving objects outside the vehicle 100 and may be detected, for example, via the object detection device 300 in FIG. 7.

In this example, the processor may determine to implement a command received from the remote device for controlling parking of the autonomous vehicle 100 (e.g., determine that the command is mandatory) if an ambient environment of the autonomous vehicle 100 is congested, for example if the number of moving objects exceeds a threshold. If the processor of the autonomous vehicle 100 determines to implement the command of the remote device (e.g., determine that the command is mandatory), then the processor of the autonomous vehicle 100 may set the second mode (the forced monitoring mode).

Once the forced monitoring mode is set, the processor of the autonomous vehicle 100 stops the autonomous vehicle 100 and receives a control signal via the remote device. The control signal received via the remote device may be any of, for example, a signal instructing driving of the autonomous vehicle 100 at or below a predetermined speed, a signal instructing output of a notification that the autonomous vehicle 100 is performing autonomous parking if moving objects are a plurality of pedestrian clusters, a signal instructing stop after completed parking, a signal instructing movement of the autonomous vehicle 100 to a designated location to pick up or let off, and a signal instructing initiation of parking after continuous waiting.

In this example, if the ambient environment becomes less congested, for example if a fewer number of moving objects than a predetermined value is detected, then the processor of the autonomous vehicle 100 may switch from the second mode (the forced monitoring mode) to the first mode (the unforced monitoring mode).

As another example of an environmental condition of the vehicle 100, one or more characteristics of a road on which the vehicle 100 travels may be a condition. For example, the width of a road on which the autonomous vehicle 100 drives may be an ambient condition.

In this example, the processor may determine to implement a command received from the remote device for controlling parking of the autonomous vehicle 100 (e.g., determine that the command is mandatory) if the width of a road ahead of the autonomous vehicle 100 is less than a predetermined value. If the processor of the autonomous vehicle 100 determines to implement the command of the remote device (e.g., determine that the command is mandatory), then the processor of the autonomous vehicle 100 may set the second mode (the forced monitoring mode).

Once the forced monitoring mode is set, the processor of the autonomous vehicle 100 receives a control signal via the remote device. The control signal received via the remote device may be any of, for example, a signal instructing driving to a parking space in a bypass path, a signal instructing continuous driving in spite of the narrow road on which the autonomous vehicle 100 is driving, and so on.

However, in this scenario, even if the width of the road on which the autonomous vehicle 100 is driving is less than the predetermined value, if the processor of the autonomous vehicle 100 determines that it is faster to drive to the parking space in the bypass path, or determines that the autonomous vehicle 100 should drive on the road unconditionally due to the absence of a bypass path, then the processor of the autonomous vehicle 100 may still set the first mode (the unforced monitoring mode), without necessarily implementing the command from the remote device.

As another example of an environmental condition of the vehicle 100, whether a parking space in which the autonomous vehicle 100 is to be parked is occupied by another vehicle may be a condition.

In this example, the processor may determine to implement a command from the remote device for controlling parking of the autonomous vehicle 100 (e.g., determine that the command is mandatory) if a moving object or a fixed object is detected in the parking space via the object detection device 300. In this case, if a suitable communication connection to the remote device is possible via the communication device 400, then the processor of the autonomous vehicle 100 may set the second mode (the forced monitoring mode). Once the forced monitoring mode is set, the user may control parking of the autonomous vehicle 100 via the remote device.

In this example, according to some implementations, even if a moving object or a fixed object is detected in the parking space via the object detection device 300, if a suitable communication connection cannot be made to the remote device (e.g., via the communication device 400), then the processor of the autonomous vehicle 100 may set the first mode (the unforced monitoring mode), and not necessarily implement the command from the remote device. In this scenario, the processor of the autonomous vehicle 100, which has the control in the unforced monitoring mode, may continue parking, appropriately avoiding the moving object or the fixed object via the object detection device 300.

As another example of an environmental condition of the vehicle 100, the risk of colliding between the autonomous vehicle 100 and an obstacle may be a condition. The processor of the autonomous vehicle 100 may determine the risk of collision based on various factors, such as a result of detecting one or more objects outside the vehicle 100 (e.g., via the object detection device 300 in FIG. 7).

In this example, the processor may determine to implement a command from the remote device for controlling parking of the autonomous vehicle 100 (e.g., determine that the command is mandatory) if the risk of colliding with an object satisfies one or more criteria, such as being higher than a threshold. In this case, the processor of the autonomous vehicle 100 may stop the autonomous vehicle 100 not to collide with the object, set the second mode (the forced monitoring mode), and transmit information about the risk of collision, such as the type of object at risk of collision, information whether a collision has actually occurred, a monitoring screen, and other information regarding the risk of collision.

In this scenario, the vehicle 100 may subsequently receive a signal from the remote device for continuation of parking of the autonomous vehicle 100. If such a signal is received from the user via the remote device, then the processor of the autonomous vehicle 100 may switch to the first mode (the unforced monitoring mode) and continue parking with autonomous control.

As another example of an environmental condition of the vehicle 100, the need for forced movement in a specific manner during movement of the autonomous vehicle 100 to the parking space may be a condition. For example, it may occur that the autonomous vehicle 100 should to move to a user-desired location due to luggage loaded in the trunk of the autonomous vehicle 100.

In this case, the processor may determine to implement a command of the remote device for controlling parking of the autonomous vehicle 100 (e.g., determine that the command is mandatory), and thus the second mode (the forced monitoring mode) is set. In this scenario, the vehicle may subsequently receive a user input from the remote device for continuation of parking, for example after the user has finished removing the luggage. If such a signal is received, then the autonomous vehicle 100 may switch to the first mode (the unforced monitoring mode) and continue parking with autonomous control.

The foregoing examples are merely illustrative, as the autonomous vehicle 100 may be configured to detect other types of environmental conditions, and automatically determine whether to implement a command received from a remote device (e.g., determine whether the command is mandatory) based on those environmental conditions.

FIG. 13 is a flowchart illustrating an example of controlling parking of an autonomous vehicle based on a command received from a remote device according to an implementation of the present disclosure. The operation illustrated in FIG. 13 may be understood as included in step 870 illustrated in FIG. 8.

First, in step 1301, the at least one processor (e.g., controller 170) of the autonomous vehicle 100 determines a monitoring mode of the autonomous vehicle 100, for example according to one or more of the foregoing implementations of FIGS. 9 to 12.

In step 1302, if the second mode (the forced monitoring mode) is determined, then the control of parking of the autonomous vehicle is allocated to the remote device. In this case, according to some implementations, only when the user transmits (e.g., continuously transmits) a control signal via the remote device does the autonomous vehicle 100 perform parking. As described before in the implementations illustrated in FIGS. 9 to 12, if user intervention is needed for parking of the autonomous vehicle, then the second mode (the forced monitoring mode) is determined. The user may intervene in overall operations of the autonomous vehicle 100 via the remote device to which the control of parking of the autonomous vehicle 100 has been allocated.

On the contrary, in step 1303, if the first mode (the unforced monitoring mode) is determined, then the control of parking of the autonomous vehicle 100 is allocated to the autonomous vehicle 100. In this case, the autonomous vehicle 100 may perform parking independently even without receiving a control signal via the remote device. As described before in the implementations illustrated in FIGS. 9 to 12, if user intervention is not needed for parking of the autonomous vehicle 100, then the first mode (the unforced monitoring mode) is determined.

For example, it may be determined that the autonomous vehicle 100 is to be parked in spite of the absence of user intervention, as is the case when a suitable communication connection cannot be established between the remote device and the autonomous vehicle 100 via the communication device 400. In such scenarios, the processor of the autonomous vehicle 100 performs parking independently, for example with assistance of the object detection device 300 or the like.

The above-described present disclosure may be implemented as code that can be written on a computer-readable recording medium and thus read by a computer system. The computer-readable recording medium may be any type of recording device in which data is stored in a computer-readable manner. Examples of the computer-readable recording medium include a hard disk drive (HDD), a solid state disk (SSD), a silicon disk drive (SDD), a read only memory (ROM), a random access memory (RAM), a compact disk ROM (CD-ROM), a magnetic tape, a floppy disc, an optical data storage, and a carrier wave (e.g., data transmission over the Internet). The computer may include a processor or a controller. The above implementations are therefore to be construed in all aspects as illustrative and not restrictive. The scope of the present disclosure should be determined by the appended claims and their legal equivalents, not by the above description, and all changes coming within the meaning and equivalency range of the appended claims are intended to be embraced therein.

What is claimed is:

1. A method of monitoring parking of an autonomous vehicle, the method comprising:
determining, based on at least one parameter, a monitoring mode for a parking operation of the autonomous vehicle;
transmitting, according to the monitoring mode, driving information about the autonomous vehicle to at least one remote device;
determining whether a command is received from the at least one remote device for controlling the parking operation of the autonomous vehicle; and
controlling the parking operation of the autonomous vehicle based on the monitoring mode and based on a determination of whether a command is received from the at least one remote device for controlling the parking operation.

2. The method according to claim 1, wherein the monitoring mode is one of a plurality of modes comprising an unforced monitoring mode and a forced monitoring mode.

3. The method according to claim 2, wherein the controlling of the parking operation of the autonomous vehicle based on the monitoring mode and based on the determination of whether a command is received from the at least one remote device further comprises:
based on a determination that the monitoring mode is the unforced monitoring mode, allocating control of the parking operation of the autonomous vehicle to the autonomous vehicle; and
based on a determination that the monitoring mode is the forced monitoring mode, allocating the control of the parking operation of the autonomous vehicle to the at least one remote device.

4. The method according to claim 3, wherein the determination of a monitoring mode based on at least one parameter further comprises:
determining a distance between the at least one remote device and the autonomous vehicle; and
based on a determination that the distance satisfies at least one threshold criteria, determining that the monitoring mode is the unforced monitoring mode; and
based on a determination that the distance does not satisfy the at least one threshold criteria, determining that the monitoring mode is the forced monitoring mode.

5. The method according to claim 3, wherein the determination of a monitoring mode based on at least one parameter further comprises:
determining whether a communication connection satisfying at least one connection criteria can be established between the at least one remote device and the autonomous vehicle;
based on a determination that a communication connection satisfying the at least one connection criteria can be established, determining that the monitoring mode is the forced monitoring mode; and
based on a determination that a communication connection satisfying the at least one connection criteria cannot be established, determining that the monitoring mode is the unforced monitoring mode.

6. The method according to claim 3, wherein the determination of a monitoring mode based on at least one parameter further comprises:
determining an expected time duration associated with the parking operation for the autonomous vehicle;
based on a determination that the expected time duration is less than a threshold, determining that the monitoring mode is the forced monitoring mode; and
based on a determination that the expected time duration is greater than or equal to the threshold, determining that the monitoring mode is the unforced monitoring mode.

7. The method according to claim 3, wherein the determination of a monitoring mode based on at least one parameter further comprises:
determining, based on at least one environmental condition of the autonomous vehicle, whether to implement a command that is received from the at least one remote device for controlling the parking operation of the autonomous vehicle;
based on a determination to implement the command, determining that the monitoring mode is the forced monitoring mode; and
based on a determination not to implement the command, determining that the monitoring mode is the unforced monitoring mode.

8. The method according to claim 7, wherein the at least one environmental condition comprises one or more criteria to be satisfied in performing the parking operation, and
wherein the method further comprises:
determining to implement the command received from the at least one remote device in order to satisfy the one or more criteria for performing the parking operation.

9. An autonomous vehicle for monitoring parking, the autonomous vehicle comprising:
a plurality of wheels;
a power source configured to power a rotation of at least one of the plurality of wheels; and
at least one processor configured to:
determine, based on at least one parameter, a monitoring mode for a parking operation of the autonomous vehicle;
transmit, according to the determined monitoring mode, driving information about the autonomous vehicle to at least one remote device;
determine whether a command is received from the at least one remote device for controlling the parking operation of the autonomous vehicle; and
control the parking operation of the autonomous vehicle based on the monitoring mode and based on a determination of whether a command is received from the at least one remote device for controlling the parking operation.

10. The autonomous vehicle according to claim 9, wherein the monitoring mode is one of a plurality of modes comprising an unforced monitoring mode and a forced monitoring mode.

11. The autonomous vehicle according to claim 10, wherein the at least one processor is configured to:
allocate control of the parking operation of the autonomous vehicle to the autonomous vehicle based on a determination that the monitoring mode is the unforced monitoring mode; and
allocate the control of the parking operation of the autonomous vehicle to the at least one remote device based on a determination that the monitoring mode is the forced monitoring mode.

12. The autonomous vehicle according to claim 11, wherein the at least one processor is configured to:
determine a distance between the at least one remote device and the autonomous vehicle;
determine that the monitoring mode is the unforced monitoring mode based on a determination that the distance satisfies at least one threshold distance criteria; and
determine that the monitoring mode is the forced monitoring mode based on a determination that the distance does not satisfy the at least one threshold distance criteria.

13. The autonomous vehicle according to claim 11, wherein the at least one processor is configured to:
determine whether a communication connection satisfying at least one connection criteria can be established between the at least one remote device and the autonomous vehicle;
determine that the monitoring mode is the forced monitoring mode based on a determination that a communication connection satisfying the at least one connection criteria can be established; and
determine that the monitoring mode is the unforced monitoring mode based on a determination that a communication connection satisfying the at least one connection criteria cannot be established.

14. The autonomous vehicle according to claim 11, wherein the at least one processor is configured to:
determine an expected time duration associated with the parking operation for the autonomous vehicle;
determine that the monitoring mode is the forced monitoring mode based on a determination that the expected time duration is less than a threshold value; and
determine that the monitoring mode is the unforced monitoring mode based on a determination that the expected time duration is greater than or equal to the threshold value.

15. The autonomous vehicle according to claim 11, wherein the at least one processor is configured to:
determine, based on at least one environmental condition of the autonomous vehicle, whether to implement a command that is received from the at least one remote device for controlling the parking operation of the autonomous vehicle;
based on a determination to implement the command, determine that the monitoring mode is the forced monitoring mode; and
based on a determination not to implement the command, determine that the monitoring mode is the unforced monitoring mode.

16. The autonomous vehicle according to claim 15, wherein the at least one environmental condition comprises one or more criteria to be satisfied in performing the parking operation, and
wherein the at least one processor is configured to:
determine to implement the command received from the at least one remote device in order to satisfy the one or more criteria for performing the parking operation.
